(19) United States
(12) Patent Application Publication
(10) Pub. No.: US 2003/0053244 A1
(43) Pub. Date: Mar. 20, 2003

(54) Optically-based position measurement apparatus

(76) Inventor: Robert A. Lewis, Cupertino, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/952,638

(22) Filed: Sep. 14, 2001

(51) Int. Cl. G11B 5/596

(52) U.S. Cl. 360/77.03; 360/78.11

(57) ABSTRACT

A disk drive system includes a light source (110), such as an LED, mounted on the magnetic head. The LED (110) is patterned to form a fine pitched mask. The diverging light off the LED radiates toward a fixed, faceted optical reflector (112). The faceted array includes a plurality of spaced aspherical reflectors. The faceted array projects a portion of the light to a diffraction limited focus detector (114).

### BACKGROUND OF THE INVENTION

1. Field of the Invention

The present invention relates to magnetic disk drives and, in particular, to magnetic head positioning.

2. Description of the Related Art

In magnetic disk drives, the data is stored as a series of magnetic field transitions on a magnetic recording surface. The transitions are placed on the surface by a magnetic transducer commonly referred to as a magnetic recording head. The transducer converts electrical energy into a magnetic field, the polarity of which is switched according to the information to be recorded. The magnetic field causes magnetization to remain in the media after the field is removed. The data is stored as binary information in the polarity reversals, or transitions, remaining in the media. The transducer used with magnetic media may also act as a detector to detect data stored as magnetic transitions. The transducer senses a magnetic field emanating from the magnetized media. The sensed magnetic field is converted into an electric signal which varies depending on the polarity of the magnetic field. Data is then decoded from the electrical signal. When the transducer places data on the recording media, the transducer is said to have written data to the media. When the transducer detects previously written data on the media, the transducer is said to have read data from the media. In general, systems for storing and retrieving data to/from magnetic media may employ a single transducer to both read and write data, or they may employ dual transducers, one to read and one to write.

The recording media is in the form of a disk, typically with data being recorded on both surfaces. Multiple disks may be provided to increase the aggregate storage capacity of the disk drive. The center hole in the media is typically called a hub. The hub is the means by which the recording media attaches to a motor, through a spindle shaft, which rotates the recording media. The head is flown over the surface of the recording media by virtue of the air movement created when the disk rotates. The flying height must be large enough to minimize the probability of head and disk contacts that could be detrimental to data integrity, but small enough so that the magnetic field generated by the write transducer establishes magnetic transitions in the recording media surface and so that a magnetic field in the media can be sensed by the transducer.

The head is placed in proximity to the recording surface and positioned over the desired data track by an actuator arm, to which it is attached via a suspension. The actuator arm moves the head radially with respect to the media surface from a position near the hub (the inside diameter (ID)) to a position near the rim (the outside diameter (OD)). Data is commonly written onto the media surface between the ID and OD in the form of sequential concentric tracks. The track width is usually slightly larger than the width of the write transducer. The concentric tracks may be subdivided into one or more sectors.

The head must be accurately positioned over the desired data track to read or write data. Head positioning is typically accomplished by way of an actuator positioning servo controller driving a voice coil motor (VCM) attached to the actuator arm. The actuator positioning servo controller makes use of pre-recorded head positioning information as well as track and sector identification information to move the head from one track to another, known as seeking to a desired track, and to position the head over the center of the desired track and at the appropriate sector along the track. The positioning and identification information is pre-recorded on one or more of the disk surfaces, in magnetic patterns which vary in both the radial and circumferential direction to provide the actuator positioning servo controller with feedback indicating the current position of the head relative to the desired track and sector.

The data head must be accurately positioned over the desired data track and data sector before user data can be stored or retrieved from a disk drive. The actuator positioning system accomplishes this by reading the pre-written positioning and identification information and using it to update the position of the actuator. The positioning and identification information is encoded onto the disk surface in the form of a pattern of accurately sized and spaced magnetic transitions, known as servo patterns, precisely recorded in both the radial and circumferential directions. These servo burst provide a radial error signals which when fed back to the radial arm position control mechanism reduce tracking error to acceptable levels.

A limiting factor in the performance of this control mechanism is the mechanical resonate frequency of the tracking arm, radial inertia, and the number of servo bursts per disk rotation. To increase the resonate frequency of the structure, and to decrease mechanical inertia, the effective size and weight of the head arm must be reduced. One way of doing so is through a two stage mechanical control of the head radial position. Coarse positioning is provided through a conventional head arm and fine positioning is provided using a piezo-electrical or electromechanical actuator. However, this approach must be combined with an increase in servo boost sectors, resulting in both significantly increased mechanical complexity and a reduction in the available storage space.

Another approach has been through the use of optical sensors. One such method focuses light beams from a laser onto a reflector attached to the tracking arm. Another approach mounts a light source and associated optics on the arm itself. However, these approaches, too, suffer from either an increase in the mechanical complexity or from poor detectors.

As such, there is a need for an improved position detector associated with a magnetic drive tracking arm.

### SUMMARY OF THE INVENTION

These disadvantages in the prior art are overcome in large part by a system and method according to the present invention. A disk drive system according to an embodiment of the present invention includes a light source, such as an LED, mounted on the magnetic head, for fine positioning. The LED is patterned to form a fine pitched mask. The diverging light off the LED radiates toward a fixed, faceted optical reflector. The faceted array includes a plurality of spaced reflectors. The faceted array projects a portion of the light to a diffraction limited focus detector.

A method for fine positioning of a disk drive actuator arm according to an embodiment of the present invention includes projecting a light beam through a mask from an end of the disk drive actuator arm. The beam is reflected from facets on a reflector onto first and second quadrature detectors. The reflector facets are configured such that a pattern from the mask impinges on at least one of the detectors at all times. Fine movements of the actuator arm, such as those induced by mechanical vibrations, are detected and the position of the arm is sensed at all times.

A disk drive positioning apparatus according to an embodiment of the present invention includes a light source positioned on an actuator arm that produces one or more incident beams; a faceted reflector configured to reflect the one or more incident beams; and a detector adapted to receive one or more incident beams from the reflector and correlate reflected beams with a position of the actuator arm.

### BRIEF DESCRIPTION OF THE DRAWINGS

A better understanding of the invention is obtained when the following detailed description is considered in conjunction with the following drawings in which:

FIG. 1 is a diagram illustrating disk drive system according to an embodiment of the invention;

FIG. 2 is a diagram illustrating the position sensor of an embodiment of the present invention;

FIG. 3 is a diagram illustrating a detector according to an embodiment of the present invention;

FIGS. 4A-E illustrate detector operation according to an embodiment of the present invention;

FIG. 5 is a block diagram of detector electronics according to an embodiment of the present invention;

FIG. 6 is a graph illustrating degrees of resolution;

FIG. 7 is a flowchart illustrating operation of an embodiment of the present invention; and

FIG. 8 is a graph illustrating residue error which may be corrected in embodiments of the present invention.

### DETAILED DESCRIPTION OF THE INVENTION

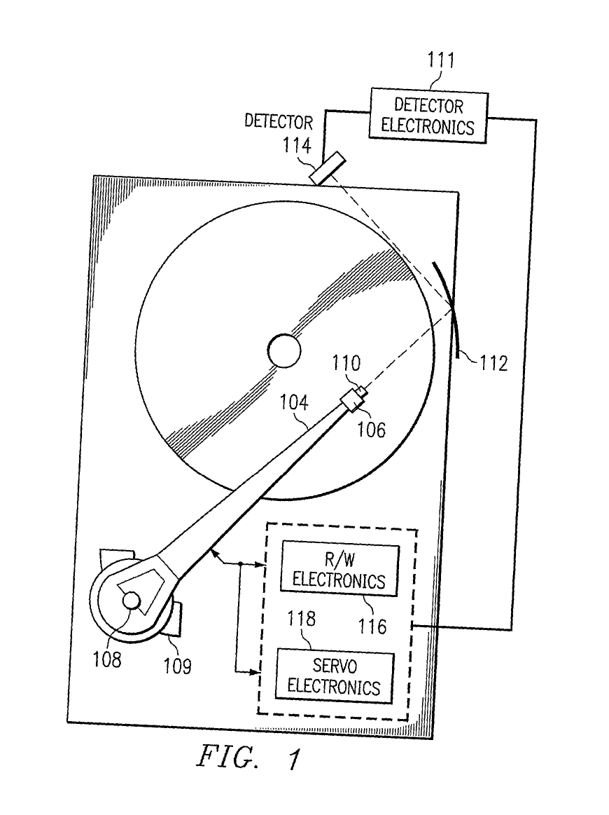

Turning now to the drawings and, with particular attention to FIG. 1, a diagram of a magnetic disk drive according to an embodiment of the invention is shown therein. Any suitable disk drive system having servo electronics and read/write electronics may be suitable for use with detection according to the present invention. The disk drive includes a disk 102, actuator arm 104 having a pivot point 108, data head 106, voice coil motor 109, LED or laser diode 110 (or VCSEL laser), detector electronics 111, reflector 112, detector 114, read/write electronics 116, and servo electronics 118.

In operation, the read/write electronics 116 sends and receives user data and provides signals to read and write the user data from and to the disk 102 through head 106. The servo electronics 118 receives signals from the read/write head when the read/write head 106 reads a servo pattern on the disk. The servo electronics 118 are used to obtain relatively precise positioning information at relatively widely spaced intervals. The servo electronics 118 receive position information and issue servo signals to provide actuator control through voice coil motor 109, effecting movement of the actuator arm 104. The disk 102 is rotated past the data head 106 at a constant rate.

The LED 110, reflector 112, reflector electronics 111, and detector 114 are used to provide additional position reference information during operation. In particular, these are used to follow position changes between sector updates. In this way, fine movements of the actuator arm, such as those induced by mechanical vibrations, are detected. As will be explained in greater detail below, in operation, once the actuator arm is in a relatively fixed position, the LED 110 directs a light beam in the direction of reflector 112. The reflector 112 directs the reflected beam into detector 114. Detector electronics 111 read the input and determine a position of the actuator arm from the received signal.

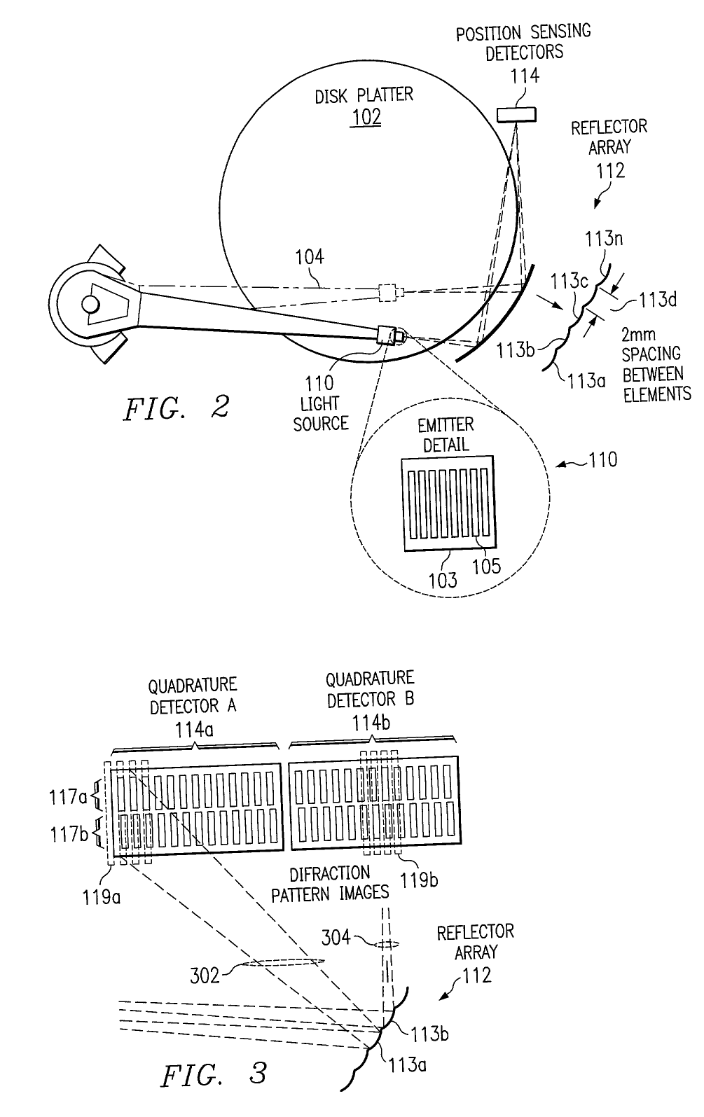

More particularly, FIG. 2 and FIG. 3 illustrate the motion detection according to embodiments of the present invention in greater detail. Shown in FIG. 2 is the platter 102, actuator arm 104, light source 110, reflector array 112, and detector 114. Shown at 103 is a detail of the light source 102's emitter mask 103. The emitter mask 103 includes a plurality of slits 105. The mask 103 may be 500 microns square and the slits 105 may have a width of 40 microns and be spaced 40 microns, center to center. The reflector array 112 includes a plurality of facets or elements 113. In on embodiment, the elements are aspherical reflectors, though any reflector suitable to direct or focus the beam(s) from the light source to the detector may be used. As shown, the reflector array 112 includes a plurality of aspherical reflectors 113 having a spacing of 2 millimeters.

FIG. 3 illustrates in greater detail the detectors 114. In the embodiment illustrated, the detector 114 is implemented as a pair of quadrature detectors 114a, 114b. Each detector 114a, 114b includes a pair of rows of slits 117a, 117b. As shown, the slits 117a are partially offset from the slits 117b. In particular, the slits 117a may be 25% offset from slits 117b. The offset quadrature detectors provide two signal channels per detector and allow for more precise detection. The detectors 114a, 114b may be implemented on a single semiconductor chip to ensure uniformity and improve mask registration. The slits may be implemented as a metal layer deposited on the semiconductor (or over an insulation layer disposed on the semiconductor layer.)

Also shown in FIG. 3 are beams 302 and beams 304 impinging on the detectors after being reflected from different facets of the reflector. As shown, the beam 302 reflects off element 113a onto detector 114a, and beam 304 reflects off element 113b onto detector 114b. In operation, each element 113 of the reflector array 112 generates an image independently of the others on the detectors 114. The orientation of the reflector facets 113 is chosen such that only one complete image of the emitter mask is present on the position detector at a given time. Thus, a series of images are formed on or intersecting the plane of the detectors which are used to derive a relative position reference.

More particularly, as shown, at least two of the reflector elements 113 are illuminated at a given time. The focus position of the reflector elements is chosen such that only two images 119a, 119b, however, appear on the detectors 114a, 114b at a given time and, in particular, only one per detector. As the actuator arm moves or wobbles, different elements (or different portions of the same elements) are illuminated and the images move on the detectors 114a, 114b. As the actuator arm moves, before one of the images 119a, 119b moves out of the field of view of one of the position detectors 114a, 114b, a full image is present on the other.

This is illustrated by way of example with reference to FIGS. 4A-E. Shown in FIG. 4A are detectors 114a, 114b and impinging patterns 119a, 119b. In the example illustrated, the image 119a is wholly on detector 114a. The image 119b is only partially on detector 114b. In certain embodiments, therefore, the receiver electronics 111 will track only the image 119a. For example, the amplitude and/or power of the signal that results from image 119a on detector 114a will be greater than that for the image 119b on detector 114b. This will be detected, and the image 199a tracked.

FIG. 4B illustrates impinging patterns 119a, 119b if the arm has moved in a direction such that the images move in the direction of the arrow (left). In this case, both patterns 119a, 119b are wholly on their respective detectors 114a, 114b. In this case, the amplitude or power of the two signals resulting from the images 119a, 119b on each of the detectors 114a, 114b should be the same. However, since the pattern 119a previously had been detected as completely on the detector 114a, it will continue to be tracked.

In FIG. 4C, the arm continues to move such that the images 119a, 119b continue to move left. Now, however, the image 119a is detected as being only partially on the detector 114a, while the image 119b is wholly on the detector 119b. That is, the amplitude or power resulting from the signal corresponding to the detected image 119a on detector 114a will decrease, and be less than that for the image 119b on detector 114b. Thus, the receiver electronics will track the image 119b.

In FIG. 4D, the images continue to move left across the faces of the detectors 114a, 114b. As shown, the image 119a is completely off the detector 114a while the image 119b is transitioning between the detectors 114a, 114b. In this case, the amplitude or power of the signal from image 119b will be split between the detectors 114a, 114b. That is, the quadrature information provided is the sum of the signals from the detectors 114a, 114b (i.e., the signal from the top slits of both detectors 114a, 114b are summed, and the signals from the bottom slits of both detectors are summed).

In FIG. 4E, the leftward movement continues and image 119b continues to be tracked and is wholly on detector 119a. A new image 119c now begins to impinge on the detector 114b, but the amplitude or signal power resulting from the image 119c is still less than that resulting from the image 119b on detector 114a. Thus, the image 119c will not be tracked until it is wholly on the detector 114b and the image 119b transitions off the detector 114a.

The images may continue to proceed left (e.g., as shown in FIG. 4A) and so on. Movement of the images in the rightward direction is tracked similarly.

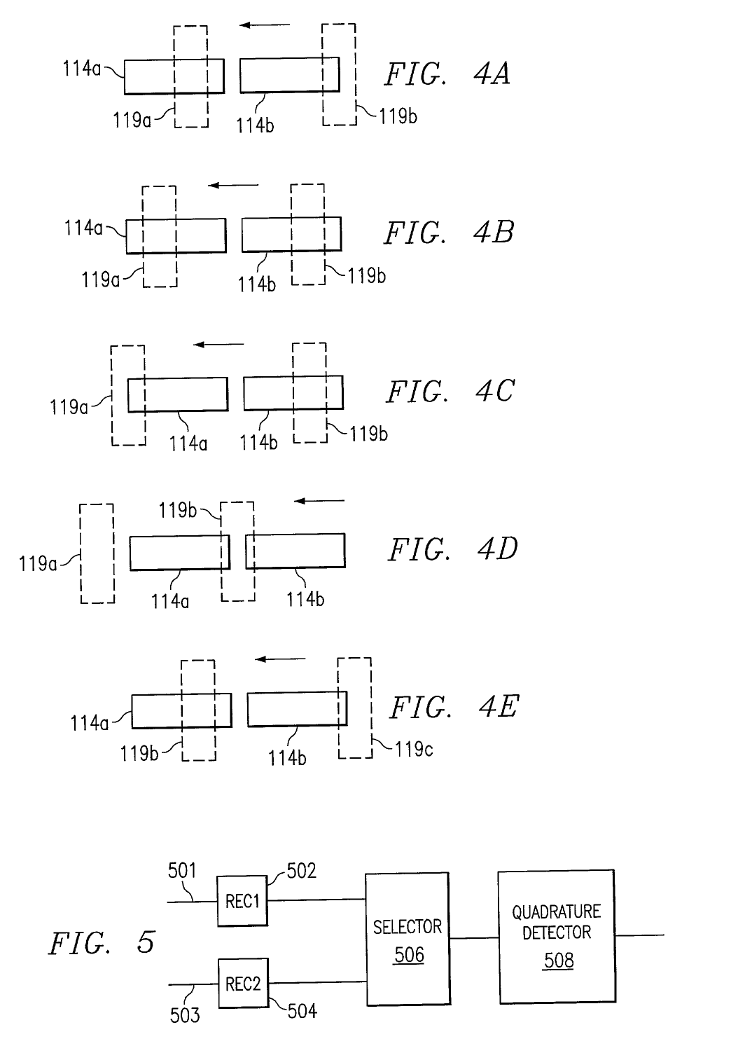

Turning now to FIG. 5, a block diagram of receiver electronics according to an embodiment of the present invention are shown. It is noted that the receiver electronics may be any combination of hardware, software, or firmware suitable to detect and process the detector signals. Thus, FIG. 5 is exemplary only.

Shown in FIG. 5 are receivers 502, 504, a selector unit 506, and a quadrature detector 508. Quadrature signals 501, 503 are received at receivers 502, 504 respectively. The signals, which are square waves, are the signals from the top and bottom rows 117a, 117b (FIG. 3) of slits (The optical signal is a square wave to support synchronous detection and the amplitude of the synchronous signal is used for quadrature demodulation. The modulation of the envelope of the signal is due to the movement of the image over the mask. The resulting quadrature signals are two sine waves separated by 90 degrees in phase.).

The signals are then provided to a selector unit 506. The selector unit 506 makes the determination of which of the images 119a, 119b is to be tracked. That is, as discussed above, the selector 506 examines the amplitude or signal power from the detector 114a and the detector 114b. Thus, in tracking, the selector 506 will select detector 114a or 114b or both 114a and 114b (i.e., receiver 502, receiver 504 or both). The resulting tracking information is provided to a quadrature detector 508. It is noted that the detector may be any appropriate detector, for detecting baseband or modulated signals. The output of the quadrature detector 508 is then used for the position determination or correlation. Processing of such a signal may be accomplished in a known manner.

It is noted that, in certain embodiments, such as those in which the detectors are formed on separate semiconductors (i.e., separate pieces of silicon), a gain control may need to be provided after one of the receivers (FIG. 5). However, if typically, the detectors are formed on a common piece of silicon, such a gain control would likely not be necessary, although localized nonuniformities resulting in a residue positional error may need to be corrected. For example, shown in FIG. 8, is a graph of actual vs. estimated positions of the actuator arm. Graph 800 illustrates the theoretical values, and 802 represents actual values. These may be compensated for through knowledge of the position information obtained using the servo. That is, since the coarse position is known, as the images 119a, 119b move across the detectors, a coarse position is known since it is known when the images begin to impinge. This information may be used to compensate for the residue positional errors.

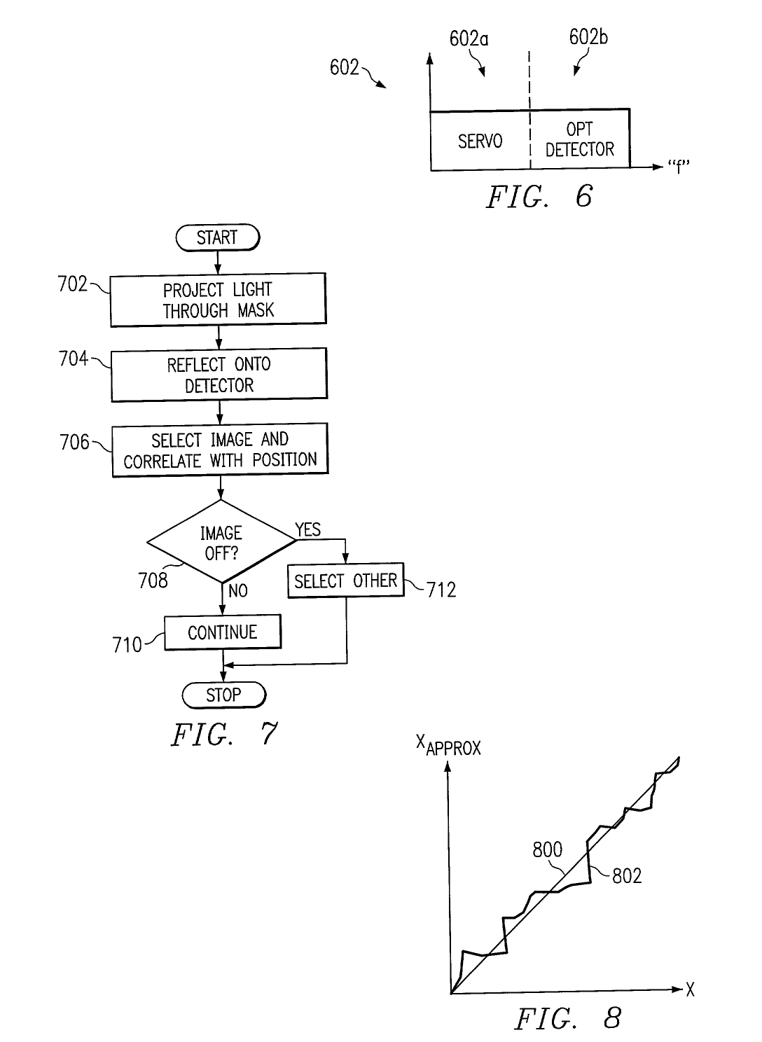

The optically-based position measurement apparatus of the present invention thus provides for higher resolution than is possible with the servo method described earlier. In particular, shown in FIG. 6 is a graph 602 representing degrees of precision for servo 602a and for the optical method of the present invention 602b. As the degree of resolution increases, the limits of capabilities of the servo 602a are reached and the optical system of the present invention takes over.

Finally, FIG. 7 is a flowchart illustrating operation of an embodiment of the present invention. In step 702, the light is projected from the end of the actuator arm through the mask. In step 704, the mask image(s) is reflected onto the detectors 114a, 114b. In step 706, an image is selected for tracking and correlated with a position. In an ongoing manner, the receiver electronics also determine, in step 708, if the tracked image has moved off the detector being tracked. In 710, the current image is continued to be tracked and correlated, if the image has not moved off the corresponding detector. However, if the image has, then the other image will be tracked and correlated, in step 712.

The invention described in the above detailed description is not intended to be limited to the specific form set forth herein, but is intended to cover such alternatives, modifications and equivalents as can reasonably be included within the spirit and scope of the appended claims.

What is claimed is:

1. A disk drive positioning apparatus, comprising:
a light source that produces one or more incident beams, said light source positioned on an actuator arm;
a reflector configured to reflect said one or more incident beams; and
a detector adapted to receive said one or more incident beams from said reflector and correlate reflected beams with a position of said actuator arm.

2. A disk drive positioning apparatus in accordance with claim 1, wherein said light source includes a patterned mask.

3. A disk drive positioning apparatus in accordance with claim 2, wherein said reflector comprises a reflector array having a plurality of reflector elements.

4. A disk drive positioning apparatus in accordance with claim 3, said reflector elements comprising aspherical elements.

5. A disk drive positioning apparatus in accordance with claim 3, said patterned mask comprising a plurality of slits.

6. A disk drive positioning apparatus in accordance with claim 5, said detector comprising at least one quadrature detector having a plurality of at least partially offset detection slits.

7. A disk drive positioning apparatus in accordance with claim 1, said light source emitting said one or more beams collinear with an axis of said actuator arm.

8. A magnetic disk drive system, comprising:
a disk;
control electronics for reading and writing to said disk;
an actuator arm including a read head;
a light source mounted on said actuator arm and adapted to emit a light beam;
at least one reflector adapted to reflect said light beam; and
a detector adapted to receive said light beam from said at least one reflector and correlate reflected beams with a position of said actuator arm.

9. A magnetic disk drive system according to claim 8, wherein said light source includes a patterned mask.

10. A magnetic disk drive system according to claim 8, wherein said reflector comprises a reflector array having a plurality of reflector elements.

11. A magnetic disk drive system according to claim 10, said reflector elements comprising aspherical elements.

12. A magnetic disk drive system according to claim 10, said patterned mask comprising a plurality of slits.

13. A magnetic disk drive system according to claim 12, said detector comprising at least one quadrature detector having a plurality of at least partially offset detection slits.

14. A magnetic disk drive system according to claim 13, said light source emitting said one or more beams collinear with an axis of said actuator arm.

15. A method, comprising:
providing a light source that produces one or more incident beams, said light source positioned on an actuator arm;
providing a faceted reflector configured to reflect said one or more incident beams; and
providing a detector adapted to receive said one or more incident beams from said reflector and correlate reflected beams with a position of said actuator arm.

16. A method in accordance with claim 15, wherein said light source includes a patterned mask.

17. A method in accordance with claim 16, wherein said reflector comprises a reflector array having a plurality of reflector elements.

18. A method in accordance with claim 17, said reflector elements comprising aspherical elements.

19. A method in accordance with claim 17, said patterned mask comprising a plurality of slits.

20. A method in accordance with claim 19, said detector comprising at least one quadrature detector having a plurality of at least partially offset detection slits.

21. A method in accordance with claim 15, said light source emitting said one or more beams collinear with an axis of said actuator arm.

22. A method in accordance with claim 15, further comprising:
providing a magnetic disk; and
providing control electronics for reading and writing to said magnetic disk.

23. A position detection method, comprising:
directing one or more light beams from a position on an actuator arm associated with a magnetic disk to one or more reflectors positioned not on said magnetic disk; and
receiving said one or more beams from said reflector and correlating reflected beams with a position of said actuator arm.
